(19) United States
(12) Patent Application Publication
(10) Pub. No.: US 2014/0165997 A1
(43) Pub. Date: Jun. 19, 2014

(54) PROCESS AND EQUIPMENT FOR THE DRY CLEANING OF SUGARCANE HARVESTED IN BILLETS AND CONTAINING STRAW AND OTHER IMPURITIES

(71) Applicants: Marcilio do Amaral Gurgel, Campinas - SP (BR); Paulo Eduardo Mantelatto, Piracicaba - SP (BR); Fernando Cesar Boscariol, Piracicaba - SP (BR); Jose Luiz Oliverio, Piracicaba - SP (BR)

(72) Inventors: Marcilio do Amaral Gurgel, Campinas - SP (BR); Paulo Eduardo Mantelatto, Piracicaba - SP (BR); Fernando Cesar Boscariol, Piracicaba - SP (BR); Jose Luiz Oliverio, Piracicaba - SP (BR)

(73) Assignee: DEDINI S/A. INDUSTRIAS DE BASE, Piracicaba - SP (BR)

(21) Appl. No.: 14/117,669

(22) PCT Filed: Jun. 20, 2012
(86) PCT No.: PCT/BR2012/000203

§ 371 Date: Feb. 7, 2014

(30) Foreign Application Priority Data
Jun. 20, 2011 (BR) PI1102849-1

(51) Int. Cl. C13B 50/00

(52) U.S. Cl. CPC C13B 50/00
USPC 127/24; 127/63

(57) ABSTRACT

The process comprises the steps of: distributing a sugarcane load, with mineral and vegetable impurities, on a conveyor belt (12), forming thereon a sugarcane and impurity mattress; submitting the mattress to a dosing and spreading operation, forming a thin and dispersed curtain in gravitational displacement in a first chamber portion (15); submitting the sugarcane and impurity curtain to a transversal and ascending forced air flow, displacing the impurities outwards from the curtain to the interior of a first collecting compartment (21) and of a second and a third chamber portion (22 and 27); deflecting the fraction of forced air flow, received in the third chamber portion (27), obtusely in a plurality of adjustable “Persian blinds” (28), decompressing the air flow; discharging the clean sugarcane load and the impurities through a clean sugarcane lower outlet (19) and through impurity outlets (21a, 23a and 26a).

### FIELD OF THE INVENTION

The present invention is related to a compact and efficient constructive solution for the dry cleaning of sugarcane harvested in billets and containing at least part of all the straw and other vegetable and mineral impurities. The invention relates, more specifically, to a process and equipment to efficiently separate, mechanically and pneumatically, in a compact construction with a relatively low energy consumption, the vegetable and mineral impurities contained in a flow or load of sugarcane harvested with the stalks cut into billets. The proposed invention further allows separating the vegetable impurities to be burned in boiler furnaces to generate steam in sugarcane processing mills.

### BACKGROUND OF THE INVENTION

The sugarcane harvested in the plantation site, in its raw form, is basically constituted by stalks, the part which concentrates the sugars and bagasse, and by vegetable impurities and mineral impurities. The mineral impurities are composed of soil material, such as sand, clay and stones aggregated to the other parts. The vegetable impurities are constituent parts of the sugarcane, such as dry and green leaves, tip and root fragments.

In industry, the object is to separate, as much as possible, the mineral and vegetable impurities from the stalks, the part which concentrates the sugars used for production of sugar and/or ethanol, as well as the bagasse used for generating steam and electric energy. The vegetable impurities must also be separated from the mineral impurities, so as to be burned in furnaces, jointly with the bagasse.

In most sugarcane processing mills, the sugarcane is discharged from the truck on a feeding table (or feeding conveyor belt), following to another conveyor belt, to be conducted to the preparation devices (choppers and crushers) and, then, to the juice extraction phase. The discharge of the sugarcane from the truck is generally made by tilting the load directly on the feeding table, in some instances directly on the “big conveyor belt” (belt installed in a level which is inferior to the load being discharged from the truck). The function of the feeding table is to standardize the sugarcane supplied to a conveying system which is inclined and ascending (45° or 60°), in the form of a sugarcane conveyor belt, which is generally defined by a chain and slat conveyor.

The systems used for cleaning the sugarcane are either sugarcane washing systems (only for the cane harvested in its entirety) or mechanical-pneumatic dry cleaning systems.

In the system for cleaning sugarcane by washing, water is sprayed over the layer of the sugarcane disposed on the feeding table, said water being collected under said feeding table and sent to a physical-chemical treatment. This system consumes large volumes of water and generates significant losses of sugar, besides large volumes of effluents with a high load of chemical oxygen demand (COD), therefore requiring an adequate treatment before the final disposal. Said washing systems are progressively less used, mainly in places where water is scarce and in sugarcane processing mills which are interested in energy co-generation from the use of straw, since said type of cleaning does not provide the separation between straw and stalk.

The sugarcane dry-cleaning system is increasingly receiving followers, mainly due to the progressive elimination of the sugarcane burning process, as well as to the progressive increase in mechanical sugarcane harvest and to water scarcity. As a function of these changes in, the plantation site, the sugarcane received in industry is more and more suffering alterations in its quality. A larger amount of soil and impurities is being brought to industry, requiring the introduction of new systems for the treatment and/or remodeling of the existing processes.

The object of the sugarcane dry-cleaning system is to separate as much as possible the straw and mineral impurities from the stalks cut into billets to be processed. The main reasons to pursue a maximum efficiency in separating impurities can be summarized as follows:
Increase of the wear in the system for preparation of the sugarcane and extraction of the juice, by the presence of straw and mineral impurities, as well as in the boilers, mainly by erosion caused by sand;
Increase in the size of the equipment for preparation, extraction (mills or diffusers) and treatment of juice (decanters and filters);
Higher power consumption for the system for preparation and extraction of the juice;
Lower extraction efficiency, coming from absorption of sugars by the straw fed in the extraction system.

There are known processes and equipment to provide pneumatic cleaning of a load of sugarcane harvested already cut into billets. According to these known solutions, the sugarcane load is submitted to a forced air flow, generally in a direction transversal to the flow of the harvested sugarcane, which is superiorly fed to a straw separating device, comprising a separating chamber. The forced air flow removes, partially, the vegetable and mineral impurities from the sugarcane flow, sending them toward a collector element, inferiorly provided with an impurity outlet. This prior art solution is described in patent documents: U.S. Pat. No. 3,384,233, U.S. Pat. No. 3,976,499, U.S. Pat. No. 38,554,585 and PI0200136-5.

In the prior art mentioned in Brazilian patent document PI0200136-5, the sugarcane and straw mattress, fed in the upper region of a separating chamber, is not submitted to any homogenization operation during its ascending conveyance from the feeding table, allowing varying the volumes of sugarcane and straw load fed in the interior of the separating chamber, to be submitted to a forced air flow which is transversal and ascending. The irregular flow and the thick width of the sugarcane and straw mattress, fed in the separating chamber, significantly affect the efficiency of the pneumatic separation of the straw from the sugarcane flow to be directed to the operations of preparation and subsequent extraction of the juice from the sugarcane.

In Brazilian Patent Application PI0805436-3, it is claimed, as novelty, the adoption of a device for leveling/homogenizing the sugarcane mattress at its feeding into the separating chamber. However, this fact is already mentioned in the prior art, in U.S. Pat. No. 3,384,233 (1968) and U.S. Pat. No. 3,854,585 (1974), and, therefore, it is not considered a novelty.

It is also known from the prior art to submit the sugarcane load in a descending displacement, to at least one forced air flow, transversal and descending, for displacing the vegetable and mineral impurities out from the sugarcane load, as described in U.S. Pat. No. 3,384,233 (1968) and U.S. Pat. No. 3,854,585 (1974). The descending air flow, described in the previous document PI0200136-5, represents a drawback in relation to the ascending flow proposed herein, since, in the latter, the friction force, between the impurities adhered to the sugarcane billets and the cross air flow is greater, requiring lower power to be applied to the device which generates the forced air flow.

Another disadvantage from the prior art, presented in documents PI0200136-5 and PI0805436-3, is the need to provide a crusher for the straw collected in the impurity separating chamber. These devices need great power to be operated and the devices available in the market require the use of blades which wear out quickly, and thus need constant maintenance and frequent replacement.

Other factors of great relevance in the sugarcane cleaning system are associated with the arrangement and form of the deflectors of the sugarcane, straw (dry and green) and air flow, to the minimum speed and to the angle of application of the air flow in relation to the descending sugarcane flow, and also with the decompression system, which factors have a significant weight in the efficiency and size of the system.

To better explain the aspects previously mentioned, FIG. 1 of the enclosed drawings defines, through the dashed line, identified by T1, the descending path of the impurity particles without air flow and, through the solid line, identified by T2, the modified path of the impurity particles due to their interaction with an air jet, whose lateral limits are marked by dot-dash lines and coming from the air duct provided just below the conveyor belt which throws the sugarcane flow, with the impurity particles, with speed Vp, in the air flow, in the interior of the separating chamber.

According to FIG. 1, the forces which act on the particle are the weight P and the drag D, the latter having the direction and sense approximately coincident with those of the air flow admitted in the interior of the separating chamber.

At this point, it is clear that the change of the path of the impurity particles, through the air flow, will depend on the angle between the duct and the direction in which the impurity particles are thrown by the conveyor belt. To facilitate the analysis, the conveyor belt was drafted in the horizontal direction. However, due to the weight force, which always acts in the vertical direction, it is clear that the angle the conveyor belt makes with the horizontal is also an important parameter to be considered.

In the simplified model, the impurity particles are considered as material elements which have a mass m, a reference area Ar and a drag coefficient Cd.

In fact, it can be verified, by people skilled in the art, that the most relevant parameters, for the effective separation of the impurities with different shapes and physical characteristics, can be summarized as follows:

1. Speed in which the particles are admitted in the separating device;
2. Angle in which the impurity particles are admitted in the separating chamber of the separating device;
3. Position of the outlet of the air jet which is used for carrying out the dry-cleaning;
4. Speed of the air jet when leaving the air tube;
5. Width of the air jet outlet (the parameters 3 and 4 define the flow required by the ventilator used in the separating device).

These important parameters are related to the ventilator power P, according to the following expression:

$$P = ρ \cdot Lv \cdot Vj \cdot \frac{I \cdot Vp}{C} \qquad Equation 1$$

wherein:
P: is the net power supplied to the air flow (equation 1);
ρ: is the density of the air;
Lv: is the width of the feeding conveyor belt;
Vj: is the speed of the air flow in the ventilator outlet duct (air flowrate/outlet duct area)
I: is the thrust of the material released by the feeding belt (see definition above);
Vp: is the speed of the feeding belt, according to the construction of the cleaning device, in the region in which occurs the admission of the sugarcane-straw mixture; and
C: is a constant defined as follows (Equation 3).

In order to occur the separation of impurity particles, it is necessary to provide a determined value for the thrust I (Equation 2), which depends on the construction of the separating device. Thus, after defining the geometry of this device and, therefore, specifying the value of the thrust I, it can be verified, through the equation above, that the power is minimized in case the speed of the air jet is reduced. It should be emphasized that the speed Vj of the air jet cannot have a null value, since it would produce a null thrust. The speed Vj of the air jet should be reduced and the jet width b should be increased, so that the thrust has a value sufficiently high to make the particle separation process become efficient. In practice, the value of the jet width b is limited for geometric reasons, so as to avoid a separating device with very high dimensions, which could lead to the increase of the thrust required.

The thrust I of the material released by the feeding belt is given by:

$$I = C \cdot \frac{{Vj}^{2} \cdot b}{{V}_{p}} \qquad Equation 2$$

wherein C is given by:

$$C = \frac{1}{2} \cdot ρ \cdot Ar \cdot Cd \cdot \frac{{f}_{1} ( Li )}{{f}_{2}^{2} ( Li )} \qquad Equation 3$$

Wherein f1 and f2 are known functions of the distance between the outlet section of the ventilation device and the interaction region, Li and Cd is the drag coefficient of the impurity particles.

The known techniques, in general, present equipment which, in practice, has low efficiency in separating the vegetable and mineral impurities from the sugarcane. For this reason, said equipment present a very high volume and are provided with high power ventilators, requiring a high investment for separating the straw and its use for generating steam and energy in the sugar and ethanol mills.

### OBJECTS OF THE INVENTION

In view of the above, related to the known separation techniques, the present invention has the object of providing a process and equipment for the dry-cleaning of sugarcane harvested with straw and in billets; to provide the separation of the mineral and vegetable impurities from the sugarcane billets, by means of a compact construction, requiring low power for its operation and resulting in a high separation efficiency, as a function of a greater spread of the different types of elements (stalk, dry straw, green leaves or green straw and mineral impurities), of the action of the feeding of the sugarcane load and of the air flow.

Said spread of the elements, which are thrown in the interior of a separating chamber, results from the different paths of the sugarcane billets, from the mixture of the sugarcane stalks and straw, from the dry straw and green straw, the latter defining the most critical condition among the several types of straw which can be admitted in the interior of the separating chamber of the device.

As previously mentioned, the amount of the thrust required to carry out the separation between the sugarcane and the straw, depends on the geometric configuration and dimensions of the separating chamber of the separating device.

The present invention has the object of providing a constructive solution which maximizes the spread of the different components of the flow of sugarcane billets thrown in the separating chamber, and which minimizes the thrust necessary to produce the separation between said components, reducing the power required in the ventilators of the separating device, as well as their size, and leading to a higher efficiency. The power required in the ventilator can be reduced to about one third of that required in the prior art separating devices. The volume of the separating device and of the cleaning equipment, as a whole, can be reduced from ten to thirteen times, and the total weight thereof can be reduced from four to five times in relation to the known constructions.

The process and the equipment of the present invention allows the straw, separated from the sugarcane stalks, to be conducted, in its integral form, to the furnace of a boiler, passing through a straw dosing-feeding device, as described in Patent Application MU9001282-8, of the same applicant.

### SUMMARY OF THE INVENTION

To overcome the deficiencies presented by the prior art, it is an object of the present invention to provide a process and equipment for the dry-cleaning of sugarcane harvested with straw, which is compact and presents low power consumption, thus allowing efficient separation of the vegetable impurities contained in the sugarcane load, as well as the posterior burn in the furnaces of the boilers which produce steam.

The results listed above are achieved through a process for the dry-cleaning of sugarcane harvested in billets, with mineral and vegetable impurities, said process comprising the steps of:

i—distributing, in a controlled speed, a sugarcane load, containing mineral and vegetable impurities, on a conveyor belt, so as to impart to said load the form of a mattress formed of sugarcane and impurities with a controlled height;
ii—submitting the sugarcane and straw mattress to a dosing and spreading operation, so as to form, with the sugarcane and straw mattress, a thin and dispersed curtain, in gravitational displacement in the interior of the first chamber portion;
iii—submitting the sugarcane and impurity curtain, in descending displacement in the interior of the first chamber portion, to a forced air flow, which is transversal and ascending, displacing the vegetable and mineral impurities outward from the curtain and to the interior of a first collecting compartment and to the interior of a second and a third chamber portion;
iv—deflecting the fraction of forced air flow, received in the third chamber portion, obtusely in a plurality of upper openings in the form of adjustable “Persian blinds”, and providing the final decompression of the remaining fraction of the air flow in a third collecting compartment, located under the third chamber portion;
v—discharging the clean sugarcane load through a sugarcane lower outlet of the first chamber portion; and
vi—discharging the vegetable and mineral impurities through lower outlets of the first collecting compartment and of the second and third chamber portions.

According to the proposed process, the sugarcane billets are gravitationally discharged, through the sugarcane lower outlet of the first chamber portion, and conducted, by a conveyor device, to juice extraction devices, the impurities being gravitationally discharged, through the impurity outlets and conducted, by an impurity conveyor device, to a mechanical separator, to be separated into vegetable impurities and mineral impurities.

The equipment of the present invention comprises:

i) a reception station to receive a load consisting of sugarcane billets and mineral and vegetable impurities;
ii) a lower-speed conveyor belt, to receive the sugarcane billet load containing vegetable and mineral impurities, and to form a first mattress with said load;
iii) a higher-speed conveyor belt, which receives the billet and impurity load from the lower-speed conveyor belt and which forms, with said load, a second mattress with approximately one third to one fifth of the height of said first mattress;
iv) a dosing chamber, presenting a prismatic shape with an elongated rectangular cross section, being superiorly open to receive the second sugarcane and impurity mattress from the higher-speed conveyor belt, and inferiorly provided with an outlet opening;
v) a rotary dosing-spreading device, receiving the second sugarcane and impurity mattress and dosing and spreading the load of said second sugarcane and impurity mattress in the interior of the dosing chamber;
vi) a first chamber portion, superiorly opened to the outlet opening of the dosing chamber, to receive therefrom a thin and dispersed curtain of said sugarcane and impurity load in gravitational displacement, said first chamber portion being internally provided with a plurality of deflectors positioned so as to conduct the sugarcane and impurity curtain toward an ascending forced air inlet, and to a sugarcane lower outlet disposed immediately below the forced air inlet;
vii) a first collecting compartment, disposed laterally and adjacently to the sugarcane lower outlet and superiorly communicating with the first chamber portion, in the region of the forced air flow inlet, to collect part of the mineral and vegetable impurities separated from the sugarcane flow, the first collecting compartment being inferiorly provided with an impurity outlet;
viii) a second chamber portion having a lower region which defines a second collecting compartment inferiorly provided with an impurity outlet;
ix) a third chamber portion, superiorly communicating with the first chamber portion, receiving part of the forced air flow which passes through the sugarcane and impurity curtain, and being superiorly provided, tangentially to the air flow and dragged impurities, with upper openings in the form of adjustable “Persian blinds”;
x) a third collecting compartment disposed under a lower region of the third chamber portion, to receive, from the latter, the impurities carried by part of the forced air flow in the interior of the third chamber portion, and being inferiorly provided with an impurity outlet; and
xi) a ventilator, producing the forced air flow to be expelled through the forced air flow inlet in the first chamber portion.

The solution proposed by the present invention dispenses the crushing of the separated vegetable impurities, since it provides a whole straw dosing device, for the boiler furnaces, according to patent application MU9001282-8, of the same applicant. The sugarcane billets, which are thrown jointly with the vegetable and mineral impurities in the interior of the first chamber portion, are dropped in free fall, colliding with a plurality of deflectors, in at least two stages, in order to release, with the sequence of collisions, the mineral and vegetable impurities adhered to the sugarcane billets. The billets and the impurities are subsequently directed to the substantially transversal and ascending forced air flow, in which the vegetable impurities are separated from the sugarcane flow and thrown to the second and third chamber portions, where they are collected to form a mineral and vegetable impurity load. The sugarcane billets which passed through the forced air flow are collected in the first collecting compartment and the mineral and vegetable impurities in the subsequent compartments, all of them being released through the respective outlets to the corresponding destinations.

The process and equipment, object of the present invention, allow obtaining an efficient separation of mineral and vegetable impurities from the sugarcane, mainly due to the following factors:
reduction of the height of the mattress of the sugarcane by action of the higher-speed feeding conveyor belt, said mattress height being reduced from one third to one fifth of the mattress height of the lower-speed conveyor belt, usually to a height of about 30-40 cm;
the reduced height of the sugarcane and impurity mattress in the higher-speed feeding conveyor belt of sugarcane, associated with the action of the billet dosing-spreading device, spacing the billets in the inlet of the first chamber portion and submitting the mattress to the sequence of collisions suffered by the sugarcane billets in gravitational flow, allows the impurities adhered to the billets to be easily released when exposed to the forced air flow;
the ascending positioning of the forced air flow in relation to the thin sugarcane billet curtain, which is dropped in gravitational flow and submitted to a sequence of collisions in a plurality of deflectors strategically positioned, ensures the efficient separation of the mineral and vegetable impurities from the curtain of sugarcane billets and impurities, requires a lower power for the operation of the equipment.

The result obtained with the arrangement disclosed in the present invention allows the power of the element which generates the forced air flow to be reduced to about one third of the known prior art devices, the volume from about one tenth to one thirteenth, and the total weight of the equipment from about one fourth to one fifth.

### BRIEF DESCRIPTION OF THE DRAWINGS

The present invention will be described below, with reference to the enclosed drawings, given by way of example of possible forms of carrying out the invention and in which:

FIG. 1 is a scheme relative to the change of the path of an impurity particle, in gravitational displacement when in free fall and when submitted to a transversal and ascending air flow;

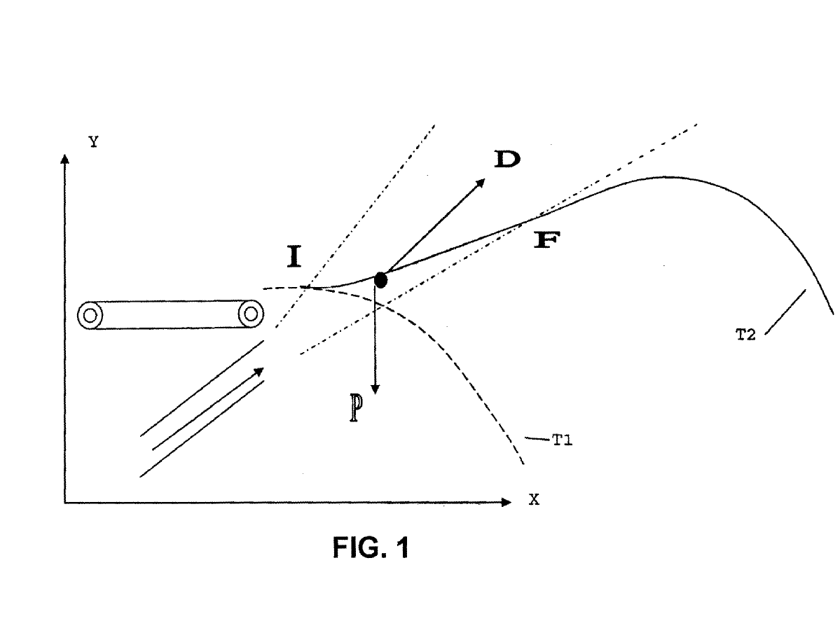

FIG. 2 is a schematic diagram showing the steps involved in the process for the dry-cleaning of sugarcane, according to the present invention;

FIG. 3 is a schematic plan view of a possible construction form of the equipment comprising the dry-cleaning device, according to the present invention;

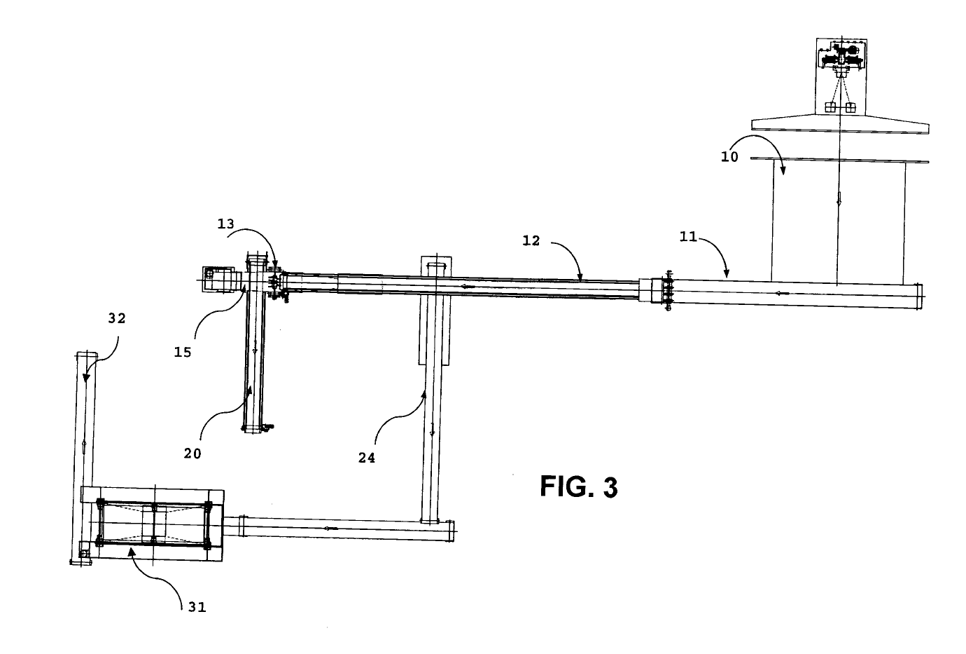

FIG. 4 is a schematic elevation view of a possible construction form of the equipment comprising the dry-cleaning device of the present invention; and

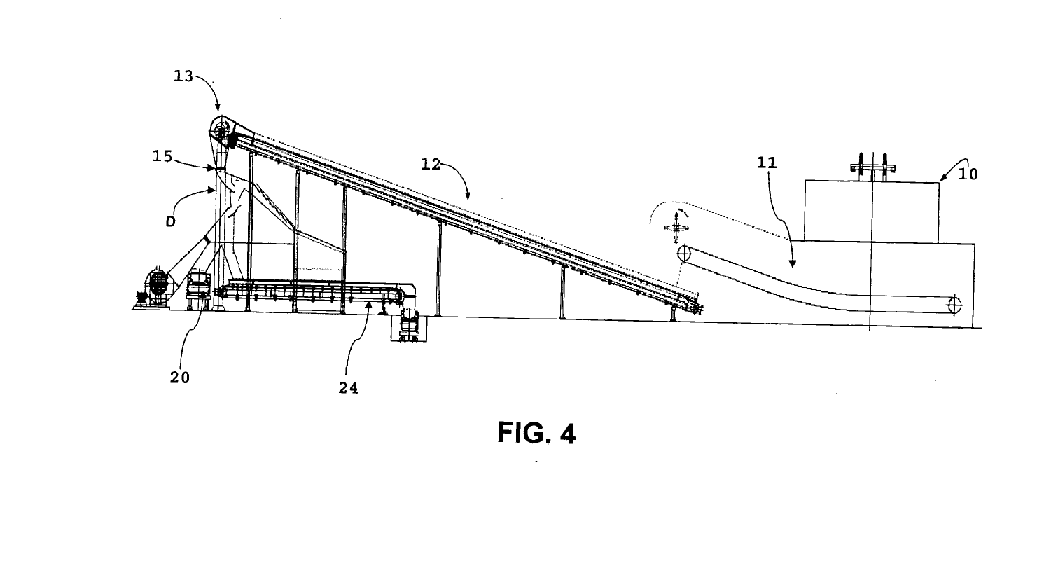

FIG. 5 is a schematic and enlarged elevation view of part of the assembly illustrated in FIG. 4.

### DETAILED DESCRIPTION OF THE INVENTION

As illustrated in the drawings, the present dry-cleaning equipment comprise, initially, a reception station 10 to receive the harvested sugarcane carrying mineral and vegetable impurities.

The reception station 10 allows the sugarcane, received therein, to be discharged on a first lower-speed conveyor belt 11, forming thereon a load consisting of sugarcane and impurities in the form of a first sugarcane and impurity mattress, with about 1 to 1.5 m of height.

The first lower-speed conveyor belt 11 discharges the first sugarcane and impurity mattress on a second higher-speed conveyor belt 12, onto which is formed a second sugarcane and impurity mattress, having about one third to one fifth of the height of the first sugarcane mattress in the first conveyor belt 11. Generally, the height of the second sugarcane mattress on the second conveyor belt 12 is of about 30-40 cm.

The second higher-speed conveyor belt 12 discharges, continuously and uniformly, the second mattress, formed by the sugarcane and impurity load, in a rotary dosing-spreading device 13, of horizontal shaft and provided with a plurality of radial vanes, arranged so as to provide the dosing and spreading of the sugarcane and impurity load in the interior of a dosing chamber 14, of prismatic shape with an elongated rectangular cross section and inferiorly provided with an outlet opening 14a, communicating the dosing chamber 14 with the upper region of a first chamber portion 15 of the separating device D.

The load formed by sugarcane and mineral and vegetable impurities, which is dosed and spread by the rotary dosing-spreading device 13 and passed through the outlet opening 14a of the dosing chamber 14, takes the form of a thin and dispersed curtain which is descendingly displaced, by gravity, in the interior of the first chamber portion 15 of the separating device D.

The first chamber portion 15 is internally provided with a first deflector 16, which is medianly and superiorly disposed above a second deflector 17, these two deflectors being disposed upstream an assembly of additional deflectors 16a, 16b, 17a and 17b positioned so as to conduct the sugarcane load, in the form of a curtain, in a descending displacement, toward different chamber portions and toward different impurity collecting compartments, as described ahead.

As a function of said deflectors, the curtain of sugarcane load is conducted toward an ascending forced air flow inlet 18 and toward a sugarcane lower outlet 19, disposed immediately below the forced air flow inlet 18.

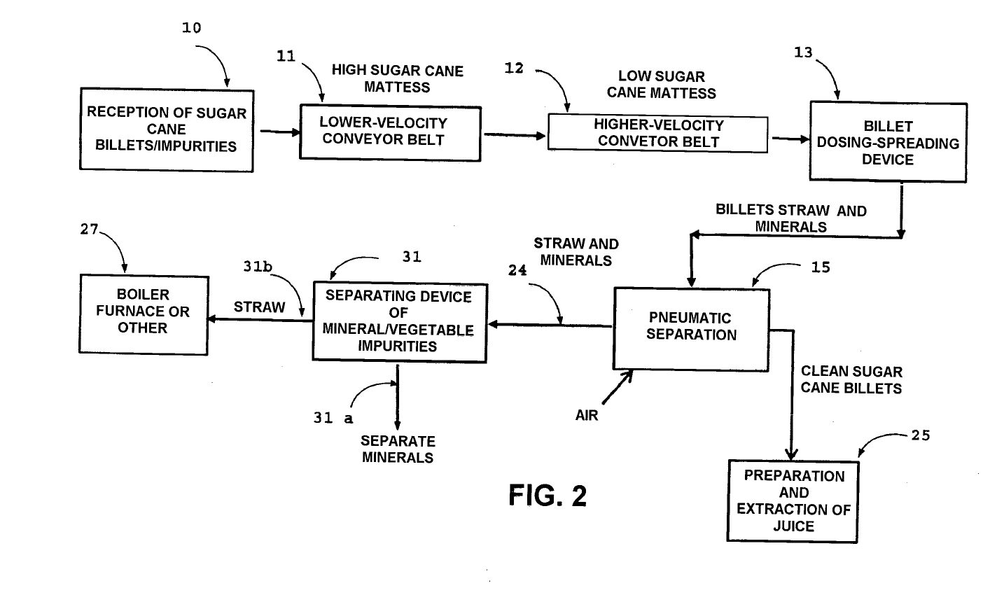

The sugarcane load is cleaned, that is, substantially separated from the impurities, by the ascending forced air flow, and discharged, by the action of gravity, through the clean sugarcane lower outlet 19 of the first chamber portion 15, in a conveyor device 20, which conducts the clean sugarcane load to the juice extraction devices 25, represented in the diagram of FIG. 2 but which are not part of the cleaning equipment of the present invention.

The separating device D also comprises a first collecting compartment 21, disposed laterally and adjacently to the clean sugarcane lower outlet 19 and superiorly communicating with the first chamber portion 15, in the region of the forced air flow inlet 18, to collect part of the mineral and vegetable impurities separated from the sugarcane flow.

The first collecting compartment 21 is inferiorly provided with an impurity outlet 21a, from which the impurities are discharged to an impurity conveyor device 24.

The separating device D also comprises a second chamber portion 22, superiorly communicating with the first chamber portion 15, by means of an admission opening 16c defined between a pair of the additional deflectors, 16a and 16b, arranged upstream and in a level above the first collecting compartment 21.

Thus, the second chamber portion 22 can receive part of the forced air flow which passes through the sugarcane flow or curtain, in a gravitational displacement, and part of the vegetable and mineral impurities, collaborating to promote a pre-decompression of the volume of air admitted in the interior of the separating device D.

The second chamber portion 22 is constructed so as to define, in a lower region, a second collecting compartment 23 which, on its turn, is provided with an impurity outlet 23a, from which the collected impurities are discharged to the impurity conveyor device 24.

The separating device D further comprises a third chamber portion 27, superiorly communicating with the first chamber portion 15, in a place located downstream the first and second deflectors 16, 17 and above the additional deflector 16a disposed immediately above the admission opening 16c of the second chamber portion 22.

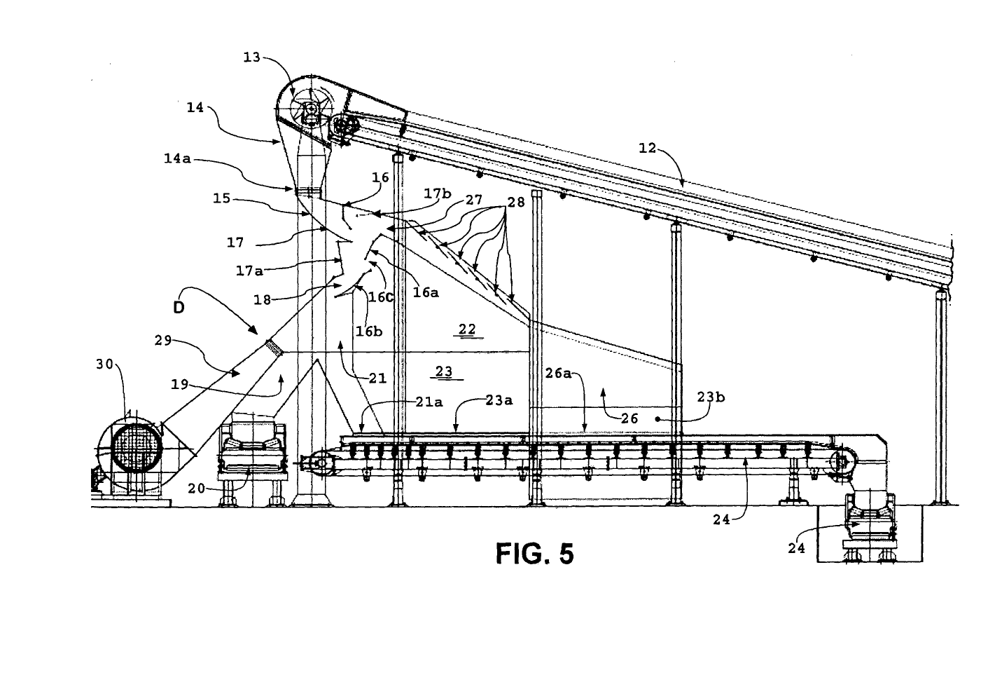

As can be noted in FIG. 5, the process and equipment of the present invention make the sugarcane and impurity curtain be deflected, in the interior of the first chamber portion 15, by one of the additional deflectors 16a, to assume a path which is descending and orthogonal to the direction of the path of said curtain upstream the deflection, that is, upstream said additional deflector 16a.

The third chamber portion 27 receives part of the forced air flow which passes through the sugarcane flow or curtain in gravitational displacement, being superiorly provided, tangentially to the air flow and dragged impurities, with upper openings in the form of adjustable “Persian blinds” 28, each of them having its trailing edge overlapping the leading edge of the immediately adjacent “Persian blind”. Thus, part of the forced air flow, substantially free from impurities, is released to the atmosphere, through said adjustable “Persian blinds” 28.

The separating device D further presents a third collecting compartment 26 provided under a lower region of the third chamber portion 27, to receive, from the latter, the impurities carried by part of the forced air flow in the interior of the third chamber portion 27. The impurities collected in the third collecting compartment 26 are released through the impurity outlet 26a, from which the impurities are discharged directly on the impurity conveyor device 24.

The fraction of the forced air flow passing through the second chamber portion 22, and through the second collecting compartment 23, makes that part of the impurities, pneumatically withdrawn from the descending sugarcane curtain, be discharged, through the impurity outlet 23a of the second collecting compartment 23, directly on the impurity conveyor device 24.

The residual air flow, carrying residual impurities, continues its path toward the second and third chamber portions 22 and 27 and also toward the second and third collecting compartments 23 and 26, in the interior of the third collecting compartment 26 being carried out the final decompression of the incoming air in the separating device D.

As already mentioned, the final residual impurities, arriving to the third collecting compartment 26, are discharged, through the impurity outlet 26a, in the impurity conveyor device 24.

The third collecting compartment 26 can be also provided with lower lateral openings 23b, disposed immediately above the impurity conveyor device 24, through which the residual air flow is finally discharged, completing the full decompression of the system.

The forced air flow, expelled through the forced air flow inlet 18 in the first chamber portion 15, is produced by a ventilator 29, driven by a driving motor 30.

The separating device D is also preferably associated with a mechanical separator 31, to separate the mineral impurities from the vegetable impurities, and which is supplied by the impurity load received from the impurity conveyor device 24. The mineral impurities are returned to the soil, whilst the vegetable impurities are conveyed to be burned in the boiler furnaces or other desired destination as, for example, to the production of second-generation ethanol, synthesis gas and the like.

The process and equipment of the present invention, since they do not require the use of water, allow a drastic reduction in water consumption of the mill, reduction of the losses of sugar coming from the sugarcane washing process, and introduction of a greater amount of biomass for the production of electric energy, without losing the quality of the sugarcane juice being processed.

The result obtained with the present invention further allows that the power required by the element which generates the forced air flow (ventilator 29) is reduced to about one third in relation to that of the known prior art devices. Besides, the volume of the cleaning equipment becomes about one tenth to one thirteenth of the volume of the known equipment and the total weight of the equipment of the present invention becomes about one fourth to one fifth of the weight of the known equipment. The proposed invention also eliminates the need to crush or grind the straw, a tedious process which requires high power consumption and intense maintenance, particularly with the frequent replacement of the cutting blades.

1. A process for dry cleaning sugarcane containing impurities which comprises
i—distributing, at a controlled speed, a sugarcane load, containing mineral and vegetable impurities, on a conveyor, so as to impart to said load the form of a controlled height mattress;
ii—submitting the sugarcane and impurity mattress to a dosing and spreading operation, to form a thin and dispersed curtain, in the interior of a first chamber portion;
iii—submitting the curtain, in a descending displacement in the interior of the first chamber portion, to a transverse and ascending forced air flow, thereby displacing the vegetable and mineral impurities outward from the curtain and to the interior of a first collecting compartment, and to the interior of a second and a third chamber portion;
iv—deflecting the forced air flow, received in the third chamber portion, obtusely in a plurality of upper openings and
v—decompressing the remaining air flow in a third collecting compartment disposed under a third chamber portion;
vi—discharging the clean sugarcane load through a sugarcane lower outlet of the first chamber portion; and
vii—discharging the vegetable and mineral impurities through lower outlets of the first collecting compartment and of the second and third chamber portions.

2. The process, as set forth in claim 1, which comprises discharging the sugarcane billets through the sugarcane lower outlet of the first chamber portion and conducting the discharged billets with a conveyor device to juice extraction devices.

3. The process, as set forth in claim 2, which comprises gravity discharging the impurities through the impurity outlets and conducting the impurities with an impurity conveyor device to a mechanical separator.

4. The process, as set forth in claim 3, which comprises deflecting the sugarcane and impurity curtain in the interior of the first chamber portion to assume a descending path orthogonal to the direction of the path of said curtain, upstream of the deflection.

5. The process, as set forth in claim 1, which comprises forming the mattress by feeding the sugarcane and impurity load, to the conveyor with a second conveyor moving at a speed lower than the first conveyor.

6. The process, as set forth in claim 5, wherein the speed difference between the two conveyors belts produces a mattress on the higher-speed conveyor belt with a relative height of about one third to one fifth of the height of the mattress formed on the second conveyor belt.

7. The process, as set forth in claim 1, wherein the dosing and spreading of the sugarcane and impurity mattress is carried out by a rotary dosing-spreading device having a horizontal shaft and provided with radial vanes, throwing the sugarcane and impurity mattress in gravitational displacement into the interior of a dosing chamber disposed above the first chamber portion.

8. Equipment for the dry cleaning of sugarcane harvested in billets and containing straw and other impurities which comprises:
i—a reception station to receive a load of sugarcane billets and mineral and vegetable impurities;
ii—a lower-speed conveyor belt to receive the load of sugarcane billets and vegetable and mineral impurities, and to form a first mattress with said load;
iii—a higher-speed conveyor belt which receives the billet and impurity load from the lower-speed conveyor belt and which forms, with said load, a second mattress of about one third to one fifth of the height of said first mattress;
iv—a prismatic shape dosing chamber having an elongated rectangular cross section, and open to receive the second mattress from the higher-speed conveyor belt and being inferiorly provided with an outlet opening;
v—a rotary dosing-spreading device receiving the second mattress, and dosing and spreading the load of said second mattress in the interior of the dosing chamber;
vi—a first chamber portion, superiorly open to the outlet opening of the dosing chamber, to receive therefrom a thin and dispersed curtain of said sugarcane and impurity load in gravitational displacement, said first chamber portion being internally provided with a plurality of deflectors positioned so as to conduct the sugarcane and impurity curtain, toward an ascending forced air inlet, and toward a clean sugarcane lower outlet disposed immediately below the forced air inlet (18);
vii—a first collecting compartment, disposed laterally and adjacently to the sugarcane lower outlet and communicating with the first chamber portion in the region of the forced air flow inlet to collect part of the mineral and vegetable impurities separated from the sugarcane flow, the first collecting compartment being inferiorly provided with an impurity outlet;
viii—a second chamber portion having a lower region which defines a second collecting compartment inferiorly provided with an impurity outlet (23a);
ix—a third chamber portion, superiorly communicating with the first chamber portion, receiving part of the forced air flow which passes through the curtain, and being superiorly provided, tangentially to the air flow and dragged impurities, with adjustable upper openings;
x—a third collecting compartment disposed under a lower region of the third chamber portion to receive, from the latter, the impurities carried by part of the forced air flow in the interior of the third chamber portion, and being inferiorly provided with an impurity outlet; and
xi—a ventilator (29), producing the forced air flow to be expelled through the forced air flow inlet in the first chamber portion.

9. The equipment, as set forth in claim 8, wherein the sugarcane billets are gravitationally discharged, through the sugarcane lower outlet of the first chamber portion, in a conveyor device conducting the clean sugarcane load to juice extraction devices.

10. The equipment, as set forth in claim 9, wherein the impurities are gravitationally discharged, through the impurity outlets in an impurity conveyor device, conducting the vegetable and mineral impurities to a mechanical separator.

11. The equipment, as set forth in claim 10, wherein the third collecting compartment is provided with lower lateral openings, disposed immediately above the impurity conveyor device and through which the residual air flow is finally discharged, completing the decompression of the system.

12. The equipment, as set forth in claim 8, wherein the rotary dosing-spreading device has a horizontal shaft and is provided with a plurality of radial vanes.

13. The equipment, as set forth in claim 8, wherein each of the adjustable openings has a trailing edge overlapping the leading edge of the immediately adjacent opening.

14. The equipment, as set forth in claim 8, wherein the first chamber portion is internally provided with a first deflector which is medianly and superiorly disposed above a second deflector, said two deflectors being disposed upstream an assembly of additional deflectors positioned so as to conduct the sugarcane load, in the form of a curtain in a descending displacement, toward the sugarcane lower outlet, and to direct the vegetable and mineral impurities to the first collecting compartment and to the second and third chamber portions.

15. The equipment, as set forth in claim 14, wherein the second chamber portion communicates, superiorly, with the first chamber portion, by means of an admission opening defined between a pair of the additional deflectors arranged upstream and in a level above the first collecting compartment.
